(19) United States
(12) Patent Application Publication
(10) Pub. No.: US 2010/0187724 A1
(43) Pub. Date: Jul. 29, 2010

(54) PROCESS FOR PRODUCING A FREE-FLOWING AND STORAGE-STABLE SOLID COMPRISING ESSENTIALLY ALPHA-ALANINE-N,N-DIACETIC ACID AND/OR ONE OR MORE DERIVATIVES OF ALPHA-ALANINE-N,N-DIACETIC ACID

(75) Inventors: Robert Heinz, Ludwigshafen (DE); Karin Flore, Worms (DE); Lars Kissau, Wachenheim (DE); Thomas Heidenfelder, Dannstadt-Schauernheim (DE); Tanja Seebeck, Bensheim (DE); Frank Mrzena, Mutterstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/667,051

(22) PCT Filed: Jun. 30, 2008
(86) PCT No.: PCT/EP2008/058377

§ 371 Date: Dec. 29, 2009

(30) Foreign Application Priority Data
Jul. 3, 2007 (EP) 07111575.2

(51) Int. Cl. B29C 55/18

(52) U.S. Cl. 264/280

(57) ABSTRACT

A process is proposed for producing a free-flowing and storage-stable solid comprising essentially α-alanine-N,N-diacetic acid and/or one or more derivatives of α-alanine-N,N-diacetic acid proceeding from a powder of α-alanine-N,N-diacetic acid and/or one or more derivatives of α-alanine-N,N-diacetic acid by
a. compacting the powder of α-alanine-N,N-diacetic acid on a roller press to obtain slugs,
b. crushing the slugs and
c. screening the crushed slugs,
   which comprises performing the compaction on the roller press with addition of polyethylene glycol with a melting point greater than 35° C.

The invention relates to a process for producing a free-flowing and storage-stable solid comprising essentially α-alanine-N,N-diacetic acid and/or one or more derivatives of α-alanine-N,N-diacetic acid, and to use of the solid produced by the process.

α-Alanine-N,N-diacetic acid and derivatives thereof are known as biodegradable complexing agents for alkaline earth metal and heavy metal ions in detergent formulations for dishware cleaning under the brand name Trilon® M from BASF AG, and are described, for example in EP-A 0 781 762.

α-Alanine-N,N-diacetic acid is prepared by spray-drying a corresponding reaction mixture and is obtained as an amorphous, extremely hygroscopic powder which, as such, owing to its hygroscopicity, is not directly suitable for use for producing tabs for machine dishwashers by mixing with further components, especially enzymes, peroxides, soda, etc., and compressing the mixture to tablets.

There has therefore been a search for possible solutions by which the α-alanine-N,N-diacetic acid obtained in powder form in the production process can be converted to a form which is suitable for use in the above process for producing tabs for machine dishwashers.

In the process of EP-A 0 845 456, α-alanine-N,N-diacetic acid powder is converted by buildup granulation, by mixing the powder with a granulating liquid, drying and screening, to the form of a granule, i.e. a particulate and readily pourable solid, which is present in crystalline form and is known as Trilon® M granule from BASF AG. However, a problem in this context is that, in the subsequent further processing of the Trilon® M granule to tabs for machine dishwashers, massive caking occurs on the press dies.

Even though the connections have not entirely been clarified, it is assumed that the conglutination of the press dies is caused by a change in the granule in the course of pressing, the granule being crushed.

It is known that bulk materials can be compacted on roll compactors, for example also in laundry detergent production (cf. Martin Holl in; Chemie, Anlagen and Verfahren [Chemistry, plants and processes], August 2001 edition). In this case, the raw materials are supplied via a filling funnel, frequently with screw conveyors, to a roller gap between two rollers of a roller pair, and compaction is effected under pressure in the roller gap to obtain slugs which, in a crushing plant, are crushed to granules of desired size and then screened.

However, the α-alanine-N,N-diacetic acid powder is not readily compactable without further additives.

Polyethylene glycols are known as Pluriol® E brands from BASF AG and are used, for example, as consistency regulators and binders in cleaning composition tablets (cf. Pluriol® E brands, technical information from BASF AG, May 2005).

It was an object of the invention to provide a process for producing a free-flowing and storage-stable solid comprising essentially α-alanine-N,N-diacetic acid and/or one or more derivatives of α-alanine-N,N-diacetic acid, which can be used to produce tabs for machine dishwashers by mixing with further additives and tablets without the disadvantages described above.

Accordingly, a process has been found for producing a free-flowing and storage-stable solid comprising essentially α-alanine-N,N-diacetic acid and/or one or more derivatives of α-alanine-N,N-diacetic acid proceeding from a powder of α-alanine-N,N-diacetic acid and/or one or more derivatives of α-alanine-N,N-diacetic acid by
a. compacting the powder of α-alanine-N,N-diacetic acid and/or one or more derivatives of α-alanine-N,N-diacetic acid on a roller press to obtain slugs,
b. crushing the slugs and
c. screening the crushed slugs,
   which comprises performing the compaction on the roller press with addition of polyethylene glycol with a melting point greater than 35° C.

The process proceeds from a powder of α-alanine-N,N-diacetic acid and/or of one or more derivatives of α-alanine-N,N-diacetic acid, which is compacted in a roller press under pressure in the roller gap thereof. The intake into the roller gap is usually affected by means of a bulk material funnel, a screw conveyor frequently being arranged in the bulk material funnel.

Slugs are obtained from the roller gap, i.e. more or less strip-like intermediates, which are formed in the roller compaction through compressing of the starting material and which are then crushed in a crushing plant and screened.

According to the invention, a polyethylene glycol with a melting point above 35° C. is applied to the roller press together with the powder of the α-alanine-N,N-diacetic acid and/or of one or more derivatives of α-alanine-N,N-diacetic acid. The limitation to polyethylene glycol types with melting points greater than 35° C. is necessary to ensure that the polyethylene glycol does not liquefy in the compaction process.

Preference is given to using polyethylene glycols with a melting point greater than 40° C.

Accordingly the Pluriol® E 1500, Pluriol® E 4000 powder or Pluriol® E 6000 powder polyethylene glycol types, which are known under the BASF AG brand name Pluriol®, are used with particular preference.

The mixing ratio between the powder composed of α-alanine-N,N-diacetic acid and/or one or more derivatives of α-alanine-N,N-diacetic acid and the polyethylene glycol powder is preferably selected such that the addition of polyethylene glycol is between 2 and 20% by weight, based on the total weight of α-alanine-N,N-diacetic acid powder and/or one or more derivatives of α-alanine-N,N-diacetic acid and polyethylene glycol powder. More preferably, the addition of polyethylene glycol is selected between 5 and 15% by weight, based on the total weight of α-alanine-N,N-diacetic acid powder and/or one or more derivatives of α-alanine-N,N-diacetic acid and polyethylene glycol powder. Especially preferred is an addition of polyethylene glycol of 7% by weight, based on the total weight of α-alanine-N,N-diacetic acid powder and/or one or more derivatives of α-alanine-N,N-diacetic acid and polyethylene glycol powder.

The compaction in the roller press is preferably carried out under a pressure, based on the roller width and the roller diameter, of from 2 to 10 N/mm×mm.

The invention also provides for the use of the free-flowing and storage-stable solid produced by the above-described process for producing tabs for machine dishwashers by mixing with further additives, especially with enzymes, peroxides and soda, and subsequent tabletting.

A process has thus been found which improves the compactibility of powders of α-alanine-N,N-diacetic acid and/or one or more derivatives thereof and simultaneously lowers their hygroscopicity, using an assistant which is intrinsic to the process for application as intended, that of producing tabs for machine dishwashers.

The invention is illustrated in detail below with reference to a figure and to working examples.

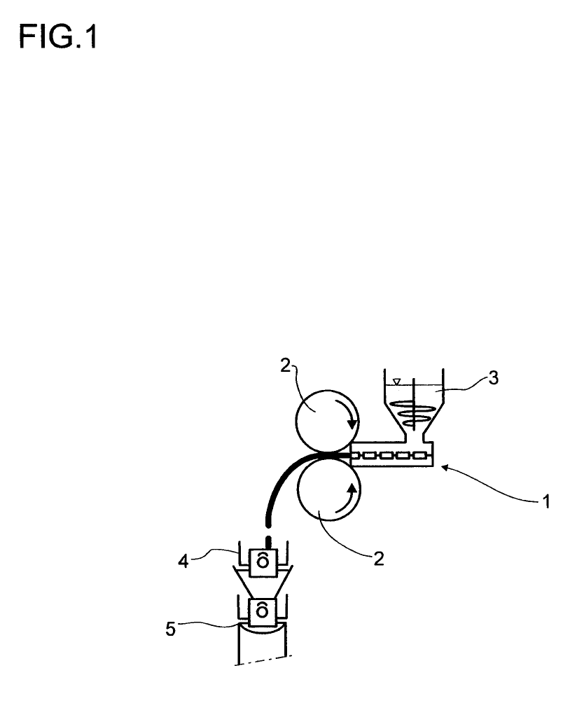

The sole figure, FIG. 1, shows the schematic illustration of a roller press 1 with two contrarotatory rollers 2, with a feed of the powder to be compacted, in the illustrative embodiment shown in the figure, via a bulk material funnel 3, to form slugs which are crushed to the desired size in a crushing plant 4 and screened in a screening plant 5.

### WORKING EXAMPLES

In a Hosokawa Bepex L200/50 Laborkompaktor® laboratory compacter, Trilon® MX from BASF AG (α-alanine-N,N-diacetic acid) was compacted to obtain slugs. The slugs were crushed and then screened.

In addition to Trilon® MX, polyethylene glycols with different degrees of polymerization and accordingly with different melting points were used, specifically Pluriol® polyethylene glycol types from BASF AG with a mean molar mass of 4000 (Pluriol® E 4000) or with a mean molar mass of 6000 (Pluriol® E 6000).

The L 200/50 Laborkompaktor® was equipped with rollers with a 6 mm fine profile, which were operated at a speed of 7.5 revolutions per minute. The pressure on the rollers, based on the roller width and the roller diameter, was from approx. 8 to 10 N/mm×mm.

The resulting slugs were crushed and screened in a screening plant into three screen fractions, a first fraction with a screen size of 0.25 mm, a mean fraction with a screen size of from 0.355 to 1.25 mm, and a third fraction with a screen size of less than 0.355 mm.

Comparative Experiments:

For comparison, Trilon® MX was compacted without addition of polyethylene glycol: this afforded a product which, in the subsequent process for compression to tablets for the production of tabs for dishwashing compositions, led to the conglutination of the press dies.

In a further comparative experiment, Trilon® MX was compacted together with 20% by weight of Pluriol® E 4000 from BASF AG; in the course of this, the temperature of the product rose so greatly in the course of compaction that comminution thereof by grinding was possible only after cooling.

In a further comparative experiment, a polyethylene glycol with a higher mean molar mass of 6000, specifically Pluriol® E 6000 from BASF AG, was used. A product was obtained which, in terms of process technology, is suitable for use in a subsequent process for producing tabs for machine dishwashers, but is unsuitable in the end application owing to the high molecular mass.

In an inventive working example, Trilon® MX was compacted together with 7% by weight of Pluriol® E 4000 from BASF AG, based on the total weight of Triton® MX and Pluriol® E 4000, on the above-described Laborkompaktor® L 200/50. After crushing the slugs and screening to the three screen fractions specified above, a granule with the following screen fractions was obtained: sieve fraction with a screen size of 1.25 mm 20.81%, screen fraction with a screen size of between 0.355 mm and 1.25 mm 38.81%, and screen fraction with a screen size of less than 0.355 mm 40.38%.

The resulting granule could be pressed without any problem, after mixing with additives, to give tabs for machine dishwashers.

1-6. (canceled)

7. A process for producing a free-flowing and storage-stable solid comprising α-alanine-N,N-diacetic acid or one or more derivatives of α-alanine-N,N-diacetic acid proceeding from a powder of α-alanine-N,N-diacetic acid or one or more derivatives of α-alanine-N,N-diacetic acid, or a mixture thereof, said process comprising
a) compacting the powder of α-alanine-N,N-diacetic acid or one or more derivatives of α-alanine-N,N-diacetic acid, or a mixture thereof, on a roller press to obtain slugs,
b) crushing the slugs, and
c) screening the crushed slugs,
wherein said compacting is carried out on the roller press with addition of polyethylene glycol with a melting point greater than 35° C., and where in the addition of polyethylene glycol for compaction on the roller press is from 2 to 15% by weight, based on the total weight of the powder composed of α-alanine-N,N-diacetic acid or one or more derivatives of α-alanine-N,N-diacetic acid, or a mixture thereof, and polyethylene glycol supplied to the compaction on the roller press.

8. The process according to claim 7, wherein the compaction on the roller press is carried out with addition of polyethylene glycol with a melting point greater than 40° C.

9. The process according to claim 7, wherein the addition of polyethylene glycol for compaction on the roller press is from 5 to 15% by weight, based on the total weight of the powder composed of α-alanine-N,N-diacetic acid or one or more derivatives of α-alanine-N,N-diacetic acid, or a mixture thereof, and polyethylene glycol supplied to the compaction on the roller press.

10. The process according to claim 9, wherein the addition of polyethylene glycol for compaction on the roller press is 7% by weight, based on the total weight of the powder comprising α-alanine-N,N-diacetic acid or one or more derivatives of α-alanine-N,N-diacetic acid, or a mixture thereof, and polyethylene glycol supplied to the compaction on the roller press.

11. The process according to claim 7, wherein the compaction in the roller press is carried out with a pressure on the rollers, based on the roller width and the roller diameter, of from 2 to 10 N/mm×mm.

12. A method of using the free-flowing and storage-stable solid comprising α-alanine-N,N-diacetic acid or one or more derivatives of α-alanine-N,N-diacetic acid, or a mixture thereof, produced according to claim 7 for producing tabs for machine dishwashers by mixing with further additives and pressing to tabs.
